(19) United States
(12) Patent Application Publication
(10) Pub. No.: US 2019/0131730 A1
(43) Pub. Date: May 2, 2019

(54) ENHANCED EXPANSION SLOT CONNECTOR

(71) Applicant: Super Micro Computer, Inc., San Jose, CA (US)

(72) Inventors: Terry TENG, San Jose, CA (US); Te HUANG, Taipei (TW)

(21) Appl. No.: 15/801,298

(22) Filed: Nov. 1, 2017

(51) Int. Cl. H01R 12/71; H01R 13/6473; H01R 12/70

(52) U.S. Cl. CPC H01R 12/716; H01R 13/6473; G06F 1/185; H01R 2201/06; H01R 12/7052

(57) ABSTRACT

An expansion slot connector has length-reduced termination portions for surface-mounting onto a printed circuit board, while maintaining compliance with defined standards, manufacturer specifications, and signal integrity demands. At least one advantage in this approach is that the physical footprint of the slot connector is reduced.

### BACKGROUND OF THE INVENTION

### Field of the Invention

Embodiments of the present invention relate generally to computer buses, and, more specifically, to an enhanced computer bus expansion slot connector.

### Description of the Related Art

The functionality of a computer system may be expanded through the use of expansion cards. One or more expansion slot connectors may be mounted onto a printed circuit board (PCB), such as a motherboard, in a computer system. An expansion card may be attached to the computer system via insertion into a slot connector. The expansion slot connector is connected to a computer bus in the computer system, and thus couples the expansion card to the computer bus. An expansion slot connector may be mounted onto the PCB by any of several methods, for example by through-hole mounting or surface mounting the conductive leads of the slot connector to the PCB.

Various computer bus standards have been defined, and a standard may have multiple revisions, with later revisions supporting higher performance targets (e.g., transmission speeds). For example, a popular standard for computer buses today is the Peripheral Component Interconnect Express (also referred to as PCI Express, PCIe or PCI-e) standard. The PCI Express standard has had multiple revisions, with later revisions supporting higher speeds. For example, the PCI Express 3.0 standard supports a bit rate of 8 gigatransfers per second, and the PCI Express 4.0 standard supports a bit rate of 16 gigatransfers per second.

Transmissions become more prone to errors at higher speeds. Therefore, as the supported performance targets of computer buses and associated expansion slot connectors increase, the demand on maintaining a level of signal integrity also increases. The through-hole mounting method is typically not able to handle the signal integrity needed to achieve the higher performance targets. The surface mounting method is thus emerging as a favored method for mounting slot connectors to PCBs. However, the surface mounting method poses challenges of its own, as a surface-mounted slot connector typically occupies a larger physical footprint in order to provide sufficient physical support for the slot connector. This larger footprint can pose a challenge for designers of PCB layouts, including the layouts of riser cards.

As the foregoing illustrates, what is needed in the art are expansion slot connectors that can support increasing performance targets on a smaller physical footprint.

### SUMMARY OF THE INVENTION

One embodiment of the present invention sets forth an apparatus including an expansion slot connector configured to be mountable onto a printed circuit board (PCB). The expansion slot connector includes a connector body, and a plurality of conductive elements arranged within the connector body. Each conductive element includes a mounting portion protruding from the connector body, and the mounting portion includes a termination sub-portion. When the expansion slot connector is mounted onto the PCB, the termination sub-portion is coupled to the PCB, is substantially parallel to the PCB, and extends beyond the connector body without forming contact with any other expansion slot connector mounted onto to the PCB directly proximate to the expansion slot connector or with a different termination sub-portion of any other expansion slot connector mounted onto to the PCB directly proximate to the expansion slot connector.

Another embodiment of the present invention sets forth an apparatus including an expansion slot connector configured to be mountable onto a printed circuit board (PCB). The expansion slot connector includes a connector body, and a plurality of conductive elements arranged within the connector body. Each conductive element includes a mounting portion protruding from the connector body, and the mounting portion includes a termination sub-portion. When the slot connector is mounted onto the PCB, the termination sub-portion is coupled to the PCB and is substantially parallel to the PCB. A plurality of characteristics associated with the conductive element is configured to substantially maintain a predefined impedance range throughout the conductive element, the plurality of characteristics including a length of the conductive element, and a length of the termination sub-portion.

Another embodiment of the present invention sets forth a system including a printed circuit board (PCB) and an expansion slot connector mounted onto the PCB. The expansion slot connector includes a connector body, and a plurality of conductive elements arranged within the connector body. Each conductive element includes a mounting portion protruding from the connector body, and the mounting portion includes a termination sub-portion. When the expansion slot connector is mounted onto the PCB, the termination sub-portion is coupled to the PCB, is substantially parallel to the PCB, and extends beyond the connector body without forming contact with any other expansion slot connector mounted onto to the PCB directly proximate to the expansion slot connector or with a different termination sub-portion of any other expansion slot connector mounted onto to the PCB directly proximate to the expansion slot connector.

At least one advantage of this approach is that the physical footprint of the slot connector is reduced while maintaining compliance with defined standards and supporting higher performance targets. This allows more components or elements to the placed on the PCB without conflict.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is an image illustrating examples of conventional expansion slot connectors;

FIG. 1B is a side sectional view of a conventional expansion slot connector;

FIG. 2 is a side sectional view of an expansion slot connector mounted onto a printed circuit board, according to various embodiments of the present invention;

FIG. 3 is a top sectional view of the expansion slot connector mounted onto a printed circuit board, according to various embodiments of the present invention;

FIG. 4 is an image illustrating example expansion slot connectors, according to various embodiments of the present invention;

FIG. 5 is a block diagram of a computer system, according to various embodiments of the present invention;

FIG. 6 is a top view of a solder pad layout, on a printed circuit board, for a conventional expansion slot connector; and

FIG. 7 is a top view of a solder pad layout, on a printed circuit board, for an expansion slot connector according to various embodiments of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

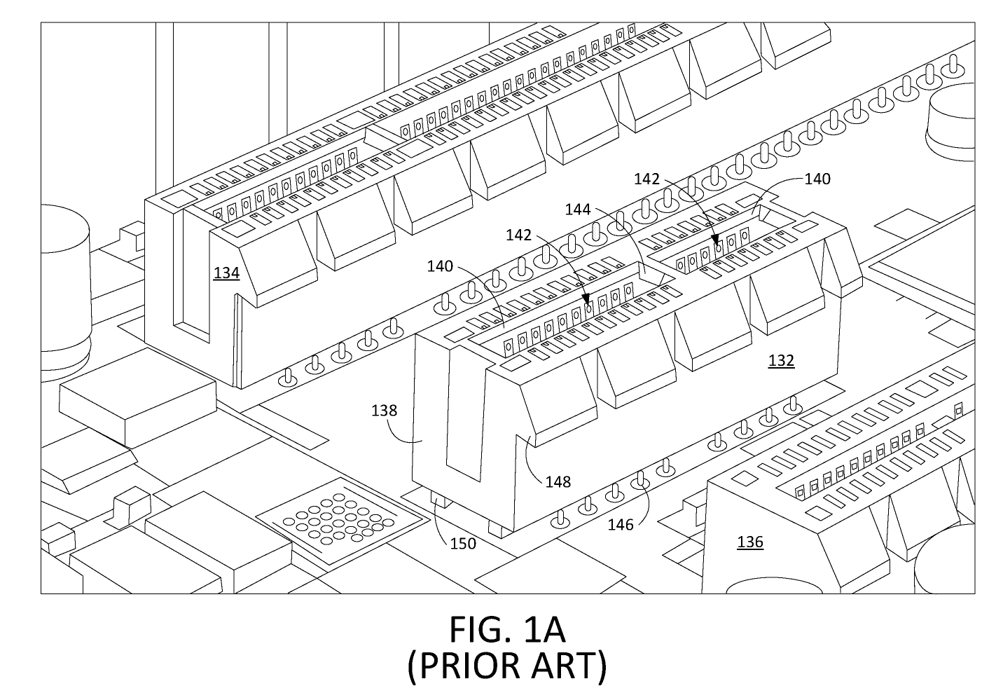

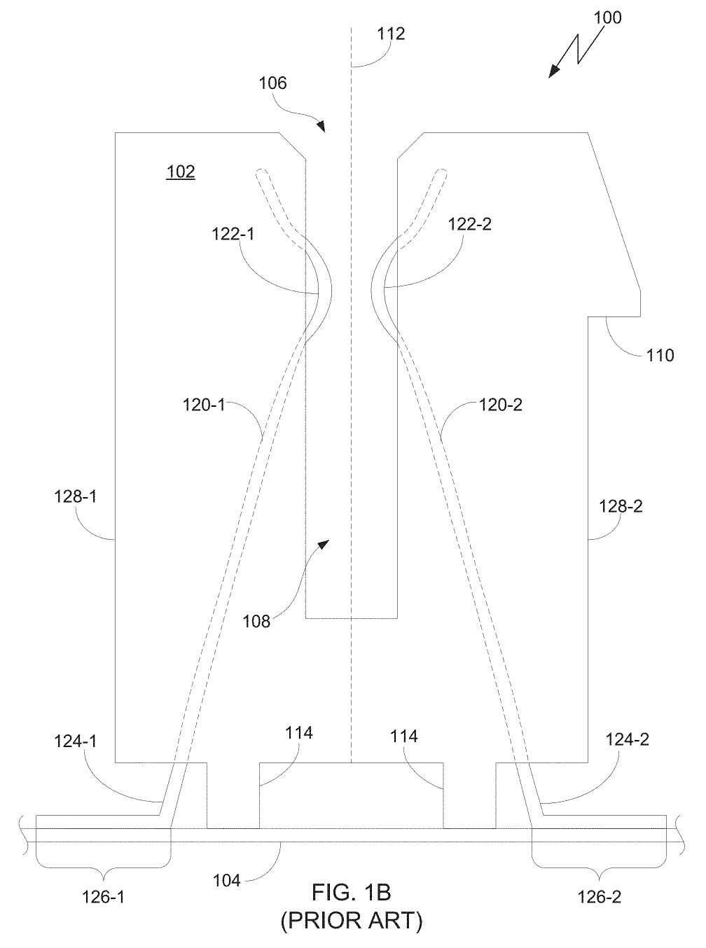

FIG. 1A is an image illustrating examples of conventional expansion slot connectors. The image shows three expansion slot connectors 132, 134, and 136. The image shows a complete view of slot connector 132, and partial views of slot connectors 134 and 136.

Each of the three slot connectors 132, 134, and 136 has a connector body with an opening at the top of the connector body. For example, slot connector 132 has a connector body 138 with an opening 140 at the top side of the connector body 138. The opening 140 runs lengthwise along the connector body 138. The opening 140 opens into a recessed area 142 of the connector body 138 that also runs lengthwise along the connector body 138. The recessed area 142 receives the edge connector of an expansion card; an expansion card is inserted into the slot connector by inserting the edge connector of the expansion card into the recessed area 142. The opening 140, and the corresponding recessed area 142, may be continuous or divided. For example, in slot connector 132, there is a connector body wall 144 across the opening 140 and the recessed area 142, dividing the recessed area 142 into two portions. The connector body wall 144 may be located off-center relative to the length of the opening 140; the connector body wall 144 is closer to one end or the other of the opening 140. The connector body wall 144 may serve as a key to the insertion polarity of an expansion card to be inserted into the slot connector; the edge connector of the expansion card may include a notch indentation that matches the connector body wall 144.

The connector body 138 may be a formed piece of non-conductive material (e.g., plastic). The connector body 138 may be substantially symmetrical about a lengthwise axis, and also substantially symmetrical about an axis that is perpendicular to the lengthwise axis and parallel to the height of the connector body 138. Connector body 138 also includes one or more inclined extensions 148 and one or more legs 150.

In FIG. 1A, slot connectors 132, 134, and 136 are mounted onto a printed circuit board (PCB), with termination pins of slot connectors 132 and 134 visible in the image of FIG. 1. For example, slot connector 132 includes multiple termination pins 146. Examples of PCBs onto which a slot connector may be mounted include, without limitation, motherboards and riser cards. Slot connectors 132 and 134 in FIG. 1A are mounted to the PCB by the through-hole mounting method. For each of slot connectors 132 and 134, the slot connector is positioned on the PCB so that a set of termination pins protruding from the bottom of the connector body are inserted into respective termination holes that have been pre-drilled through the PCB. The termination pins are substantially perpendicular to the PCB when inserted into the termination holes. The termination holes, with the termination pins inserted inside, are filled with a material (e.g., solder or other conductive material) to anchor the termination pins within the termination holes. The termination pins in the filled termination holes are conductively coupled to the PCB (e.g., to a circuit on the PCB). For example, the termination pins 146 of slot connector 132 are inserted into respective holes pre-drilled through the PCB, and the holes are filled with material to anchor the termination pins 146 in place. An alternative method for mounting slot connectors to the PCB is the surface-mounting method, which is described further below.

Each termination pin is conductively coupled to a conductive contact that protrudes from the connector body into the recessed area through a hole formed along a surface of the recessed area. For example, with reference to slot connector 132 in FIG. 1A, multiple conductive contacts protrude into the recessed area 142 through holes along the inner surface of the recessed area 142, thereby exposing the conductive contacts. There may be conductive contacts protruding into the recessed area 142 through one or both lengthwise surfaces of the recessed area 142, with each conductive contact coupled to a respective termination pin 146. Each termination pin 146 and the corresponding conductive contact may be portions of a conductive element (e.g., a single formed piece of conductive (e.g., metallic) material) of a certain length and thickness. When an expansion card is inserted into the slot connector, conductive traces on the edge connector of the expansion card are conductively coupled to respective conductive contacts protruding into the recessed area 142.

Multiple conductive elements may be arranged within a connector body 138. The conductive elements may be held in respective compartments arranged in two rows along the length of the connector body 138, on opposite lengthwise sides of the connector body 138. The connector body 138 may have a compartment for each conductive element. A conductive element may be spring-loaded in order to be held within the corresponding compartment and to maintain contact with traces on an edge connector inserted inside the recessed area 142.

FIG. 1B illustrates a side sectional view of a conventional expansion slot connector 100. The conventional slot connector 100, mounted onto a PCB 104 by the surface-mounting method, includes a connector body 102. The connector body 102 has an opening 106 that opens into a recessed area 108 recessed into the connector body 102. The connector body 102 may optionally include one or more inclined extensions 110 along one or more outer walls of the connector body 102. The slot connectors shown in FIG. 1A also have these inclined extensions. The connector body 102 may have one or more legs 114. The legs 114 are configured to rest on the PCB 104 while the slot connector 100 is mounted onto the PCB 104. The legs 114 raise the connector body 102 above the surface of PCB 104, thereby reducing the amount of surface area of the connector body 102 that is in contact with the PCB 104 while mounted. The connector body 138, opening 140, recessed area 142, inclined extensions 148, and legs 150 of slot connector 132 (FIG. 1A) are similar to connector body 102, opening 106, recessed area 108, inclined extensions 110, and legs 114, respectively, of slot connector 100.

The connector body 102 is, not including the inclined extensions 110, substantially symmetrical about an axis 112. The axis 112 is parallel to the height of the connector body 102 and perpendicular to the lengthwise axis (not shown) of the connector body 102. The axis 112 is also substantially symmetrical along the lengthwise axis of the connector body 102.

The slot connector 100 includes multiple conductive elements 120. The conductive elements 120 are arranged in two opposite rows, one row along each lengthwise side of the connector body 102. FIG. 1B shows a conductive element 120-1 in one row and a conductive element 120-2 in the opposite row. Portions of the conductive element 120-1 and 120-2 that are hidden within the connector body 102 are shown with dotted lines, and portions that are exposed are shown with solid lines. Each conductive element 120 includes a contact portion 122 that protrudes into the recessed area 108. For example, conductive element 120-1 has a contact portion 122-1 that protrudes into the recessed area 108 and is thus exposed, and conductive element 120-2 has a contact portion 122-2 that protrudes into the recessed area 108 and is thus exposed. When an edge connector is inserted inside the recessed area 108, traces on the edge connector are conductively coupled to the contact portions 122.

Each conductive element 120 also includes a mounting portion 124 for surface-mounting the connector body to the PCB 104. For example, conductive element 122-1 has mounting portion 124-1, and conductive element 122-2 has mounting portion 124-2. A mounting portion 124 has a termination sub-portion 126. For example, mounting portion 124-1 has termination sub-portion 126-1, and mounting portion 124-2 has termination sub-portion 126-2. The termination sub-portions 124 provide the conductive coupling to the PCB 104 when slot connector 100 is mounted onto the PCB, as well as being the components attached to the PCB 104 when the slot connector 100 is mounted onto the PCB 104. When the slot connector 100 is mounted onto the PCB 104, the termination sub-portion 124 is substantially parallel with the PCB 104 (e.g., within a range of angles with respect to the surface of the PCB 104, such as 0+−3 degrees). Each termination sub-portion 126 is placed on a solder pad (not shown) on the PCB 104, and coupled to the solder pad by a material (e.g., solder paste). The solder pad is coupled to a circuit on the PCB 104, and the solder paste and solder pad makes the conductive coupling between a termination sub-portion 126 and the circuit.

A termination sub-portion 126 of the conventional slot connector 100 has a length that extends beyond the lengthwise outer walls 128 of the connector body 102. For example, the termination sub-portion 126-1 extends beyond the outer wall 128-1, and the termination sub-portion 126-2 extends beyond the outer wall 128-2. The lengths of the termination sub-portions 126 affect the amount of physical support provided to the mounted slot connector 100. Typically, the longer the termination sub-portions 126, the more physical support provided to the mounted slot connector 100.

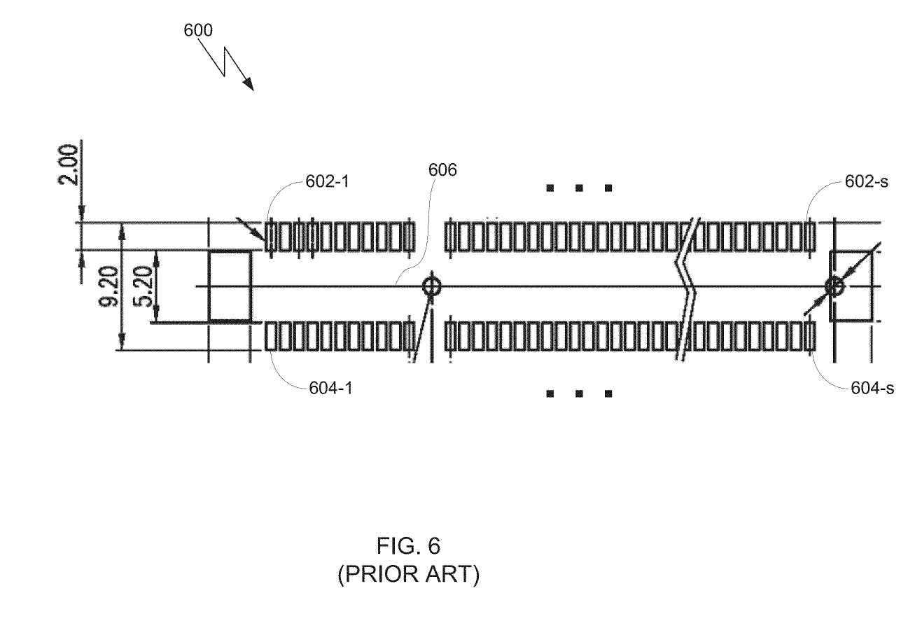

FIG. 6 illustrates an example solder pad layout 600, on a printed circuit board (e.g., PCB 104), for a conventional expansion slot connector (e.g., conventional slot connector 100, 132, 134, or 136). Dimensions shown in FIG. 6 are in millimeters. The solder pad layout 600 includes solder pads 602-1 through 602-s and 604-1 and 604-s arranged in substantially opposing rows that are substantially symmetrical about an axis 606. The axis 606 is parallel and aligned with the lengthwise axis of the connector body of the conventional slot connector (e.g., connector body 102 or 138). As shown in FIG. 6, the distance between the inner ends (the solder pad end closest to axis 606) of solder pads 602 and 604 is approximately 5.20 millimeters. The distance between the outer ends (the solder pad end furthest from axis 606) of solder pads 602 and 604 is approximately 9.20 millimeters. The length of a solder pad 602 or 604 is 2.00 millimeters. The length of the termination sub-portion 126 may be approximately the same solder pad length may be the same approximate length as. Thus, the length of the termination sub-portion 126 in conventional slot connector 100 may be approximately 2.00 millimeters.

The slot connector 100, and slot connectors 132, 134, and 136 of FIG. 1A as well, are configured to conform to a predefined computer bus standard. Examples of computer bus standards include Peripheral Component Interconnect (PCI), Accelerated Graphics Port (AGP), and PCI Express. A standard may define any number of values, thresholds, and so forth that characteristics of a conforming slot connector are required to satisfy. Slot connector characteristics for which a standard may have defined requirements include, for example, the number of conductive contacts, the corresponding pinout arrangement, the supported transmission rate and throughput, and an impedance range to be maintained throughout a conductive element in the slot connector. The standard defines values or thresholds for these and other characteristics. For example, the PCI Express standard defines a differential impedance range of 100 ohms+/−20%. Additionally, manufacturers (e.g., manufacturers of processors) may specify additional requirements, some of which may be more stringent versions of requirements defined by a standard. For example, certain manufacturers may specify, for a PCI Express slot connector, a differential impedance range of 85 ohms+/−10%, which is more stringent than the 100 ohms+/−20% specified in the PCI Express standard. A standard may also have multiple versions or revisions over time. Successive versions or revisions of a standard may improve upon prior versions or revisions. For example, the PCI Express 4.0 standard supports higher transmission rates and/or throughput than the PCI Express 3.0 standard.

The slot connector 100 is also configured to facilitate a certain level of signal integrity for signals transmitted through the slot connector 100, and slot connectors 132, 134, and 136 of FIG. 1A are respectively configured to facilitate respective levels of signal integrity as well. Multiple physical characteristics of the slot connector 100 may affect signal integrity, including a length of the conductive element 120, a length of the termination sub-portion 126, a thickness of the conductive element, distance between conductive elements within the slot connector, and so forth. As transmissions at higher speeds are more prone to errors, the demand for signal integrity increases with higher supported transmission speeds. Multiple parameters may be measured to evaluate the signal integrity of signals transmitted through the slot connector. The signal integrity may also be evaluated based on the oscilloscope eye patterns of signals transmitted through the slot connector. For example, the eye height may be measured to evaluate signal integrity; the eye height provides a measure of noise or interference. Minimum values or thresholds for these parameters, and eye patterns that represent acceptable or optimal levels of signal integrity, may be defined by a standard (e.g., the computer bus standards), may specified by a manufacturer, or may be well-known in the art as industry conventions or best practices.

Various characteristics of the slot connector 100 may be configured (e.g., at the design level by a designer) as long as the defined standard to which the slot connector conforms, and optionally any manufacturer specifications and industry conventions, as well as signal integrity demands, are met. For example, characteristics such as the actual length and width of the connector body 102, whether the connector body 102 includes any inclined extensions 110 or not, length of the conductive element 120, and so forth may be configured by a designer.

Different mounting methods for slot connectors may support different signal integrity levels. Typically, slot connectors mounted by the through-hole mounting method are capable of supporting a lower signal integrity level than the surface mounting method. At high transmission rates (e.g., the transmission rates supported by the PCI Express 4.0 standard), the level of signal integrity that the through-hole mounting method supports is insufficient. Thus, surface mounting is a preferred mounting method for slot connectors that support higher transmission rates. However, lengthy termination sub-portions of a surface-mounted slot connector enlarge the physical footprint of the slot connector.

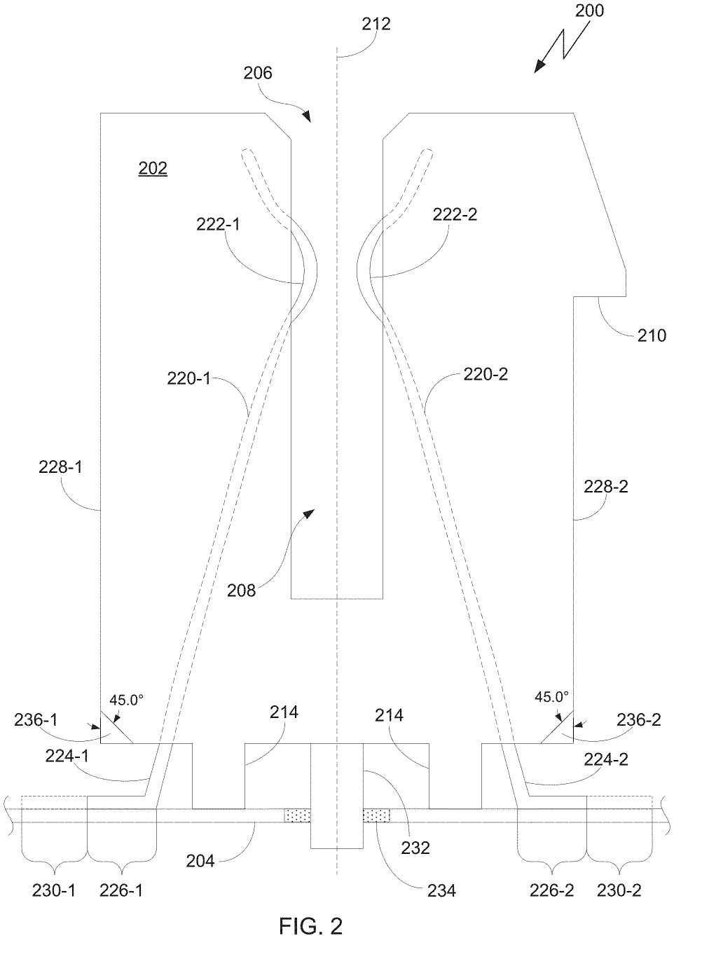

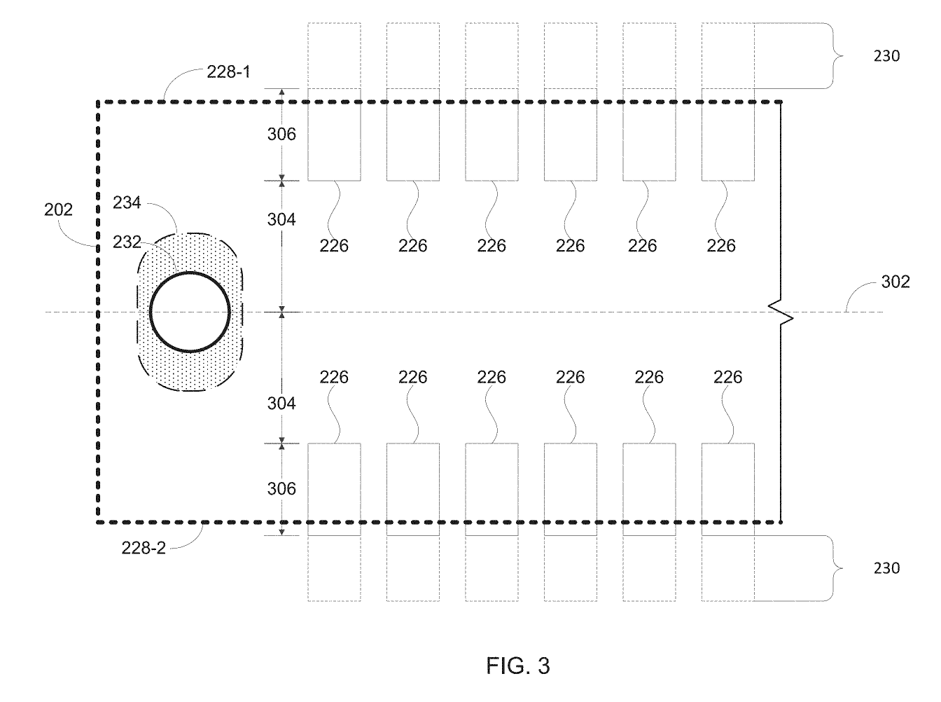

FIG. 2 is a side sectional view of an expansion slot connector 200 mounted onto a printed circuit board 204, according to various embodiments of the present invention. Slot connector 200, shown as surface-mounted to PCB 204, is in many ways similar to the conventional slot connector 100 illustrated in FIG. 1B. Slot connector 200 includes a connector body 202 with inclined extension(s) 210 and leg(s) 214. The connector body 202 has an opening 206 to a recessed area 208. The slot connector 200 is substantially symmetrical about axis 212 as well as a lengthwise axis 302 (FIG. 3) of the connector body 202.

The slot connector 200 includes multiple conductive elements 220 held in respective compartments arranged within the connector body 202 (with the portions of the conductive elements 220 that are hidden within the connector body 202 indicated by dotted lines). A conductive element 220 includes a contact portion 222 that protrudes into the recessed area 208, and a mounting portion 224 that includes a termination sub-portion 226. To mount the slot connector 200 to the PCB 204, the termination sub-portions 226 are laid on solder pads on the PCB 204 and attached to the solder pads by solder paste. A conductive element 220 is in order to be held within the corresponding compartment and to maintain contact with traces on an edge connector inserted into the recessed area 208.

As with the conventional slot connector 100, the slot connector 200 also conforms to a standard, and optionally to manufacturer specifications and industry conventions. Thus, for example, the slot connector 200 is configured to have characteristics that at a minimum conform to the standard and perhaps to the manufacturer specifications as well. For example, for a slot connector 200 that conforms to the PCI Express standard, the conductive elements 220 have a differential impedance range of 100 ohm+/−20%. The slot connector 200 is also configured to support certain signal integrity levels in accordance with standards, manufacturer requirements, or industry conventions and best practices.

The termination sub-portions 226 of the slot connector 200 extend beyond the outer walls 228 of the connector body 202 by a lesser amount than in conventional surface-mounted slot connectors (e.g., slot connector 100, FIG. 1B). For example, as shown in FIG. 2, the termination sub-portion 226-1 is shorter than the termination sub-portion 126-1 on the conventional slot connector 100 by amount 230-1, and the termination sub-portion 226-2 is shorter than the termination sub-portion 126-2 on a conventional slot connector 100 by amount 230-2. This length reduction may be made without other changes to the slot connector 200 if the slot connector 200, including the length reduction to the termination sub-portions 226, still complies with the standard, manufacturer specifications, signal integrity demands, etc. This length reduction may be made at the design level, by the designer. In some embodiments, the slot connector 200 with the reduced-length termination sub-portion 226 supports a higher signal integrity level than the conventional slot connector 100. The termination sub-portions 226 are substantially parallel (e.g., within a range of angles, such as 0+/−3 degrees) to the PCB 204 when the slot connector 200 is mounted onto the PCB 204.

In some embodiments, the termination sub-portions 226 do not extend beyond the outer walls 228. For example, the lengths of termination sub-portions 226 may be reduced such that the end of the termination sub-portions 226 are flush with or are within the outer walls 228. Regardless of whether the termination sub-portions 226 extend beyond the outer walls 228 or not, the length-reduced termination sub-portions 226 are configured to have lengths that are sufficient for attachment to the solder pads on the PCB 204.

In some embodiments, changes to other characteristics of the slot connector 200 are made in order to maintain compliance with the standard, manufacturer specifications, signal integrity demands, etc. in view of the change to the lengths of the termination sub-portions 226. For example, if the length reduction to the termination sub-portions 226 causes changes to the impedance of the conductive elements 220, other characteristics of the slot connector 200 may be reconfigured at the design level to maintain compliance with impedance requirements. Such characteristics include the lengths of the conductive elements 220, the thicknesses of the conductive elements 220, and the distance between conductive elements 220 in the connector body 202 (e.g., distance between a conductive element corresponding to a ground and a non-ground conductive element), and the spring tension of the conductive element 220. For example, the thickness of the conductive elements 220 may be increased by a certain amount in conjunction with the reduction in the length of the termination sub-portions 226. It should be appreciated that the other characteristics described above (e.g., conductive element 220 length, conductive element 220 thickness, etc.) are a non-exhaustive list of characteristics that may be changed to facilitate for the reduction in length of the termination sub-portions 226 while maintaining compliance with the standards, manufacturer specifications, signal integrity demands, etc.

In some embodiments, the slot connector 200 also includes one or more support pillars to provide additional physical support in view of the reduction of the lengths of the termination sub-portions 226. FIG. 2 shows a support pillar 232 extending from the bottom of the connector body 202. The support pillar 232 is made of non-conductive material (e.g., plastic). The support pillar 232 may be an extension of the connector body 202 (e.g., shaped from the same piece of material as the connector body 202) or a separate element integrally attached to the connector body 202. If the slot connector 200 has two support pillars, then the support pillars 232 may be arranged in proximity of each lengthwise end of the connector body 202, with one near each end; the two support pillars 232 are positioned at opposite ends of the connector body 202. If the slot connector 200 has more than two support pillars 232, the support pillars 232 may be arranged along the length of the connector body 202 (e.g., spread out evenly). In some embodiments, the support pillar 232 is shaped to be substantially rectangular or substantially cylindrical. The support pillar 232 is configured to be inserted through a hole 234 pre-drilled through the PCB 204 when the slot connector is surface-mounted onto the PCB 204. The hole 234 is larger than the width or diameter of the support pillar 232. The hole 234, with the support pillar 232 inserted inside, is filled with a material (e.g., solder) to anchor the support pillar 232 and correspondingly the slot connector 200 in place.

In some embodiments, lower corners 236 along the length of the connector body 202 may be removed (e.g., the corners 236 are removed at manufacturing, the connector body 202 is molded to not include the corners 236) from the connector body 202 to form respective beveled or chamfered edges along the length of the connector body 202. Removal of the corners 236 increases visibility of the mounting portions 224, including the termination sub-portions 226, thus facilitating visual observation and inspection of the mounting portions 224 and termination sub-portions 226. In some embodiments, a corner 236 is removed at an approximately 45-degree angle with respect to the corresponding outer wall 228 to form the beveled or chamfered edge. For example, corner 236-1 is removed at an approximately 45-degree with respect to outer wall 228-1, and corner 236-2 is removed at an approximately 45-degree with respect to outer wall 228-2.

FIG. 3 is a top sectional view of the expansion slot connector 200 mounted to a printed circuit board 204, according to various embodiments of the present invention. FIG. 3 illustrates a view from the top looking down at the slot connector 200 mounted to the PCB 204 (which in FIG. 3 corresponds to the plane of the drawing sheet), at about the level of the termination sub-portions 226. FIG. 3 shows an outline of the connector body 202 of the slot connector 200, and the outer walls 228 of the connector body 202, at one lengthwise end. As previously described, the connector body 202 is substantially symmetrical about lengthwise axis 302.

As shown in FIG. 3, the termination sub-portions 226 extend beyond the outer walls 228 of the connector body 202, but have lengths that are reduced by amount 230 compared to the lengths of the termination sub-portions 126 of the conventional slot connector 100. FIG. 3 also shows a support pillar 232 inserted through a hole 234 that is then filled with a material to anchor the support pillar 232. The hole 234, from the top-down perspective as shown in FIG. 3, may be any suitable shape. For example, in some embodiments, the hole 234 may be an oblong shape (e.g., rectangular shape with semicircular ends) as shown in FIG. 3. In some other embodiments, the hole 234 may have an oval, an elliptical, a circular, a square, or a rectangular shape. In some embodiments, the centers of the hole 234 and the support pillar 232 are aligned with axis 302. In some embodiments, the circumference of the hole 234 is lined with a material (e.g., copper, plastic). In some embodiments, the size of the hole 234 is, other than being bigger than the width or diameter of the support pillar 232, may be based on the layout of the PCB 204. For example, a designer may size the hole 234 based on sizes, types, and positions of other components around the hole 234 on the PCB 204.

In some embodiments, the slot connector 200 conforms to the PCI Express 4.0 standard. The slot connector 200, with the reduced-length termination sub-portions 226, supports the higher speeds of the PCI Express 4.0 standards while complying with the other requirements of the standard (e.g., the impedance range) or manufacturer requirements, as well as signal integrity demands.

In some embodiments, the lengths of the termination sub-portions 226, and how far the termination sub-portions 226 extend beyond the outer walls 228, may be measured with reference to axis 302 (FIG. 3). For example, dimension 304 indicates the distance from axis 302 where the termination sub-portion 226 begins, with each termination sub-portion beginning at substantially the same distance 304 from axis 302. Dimension 306 indicates the lengths of the termination sub-portions 226. The sum of dimensions 304 and 306 indicates substantially how far a termination sub-portion 226 extends out from axis 302.

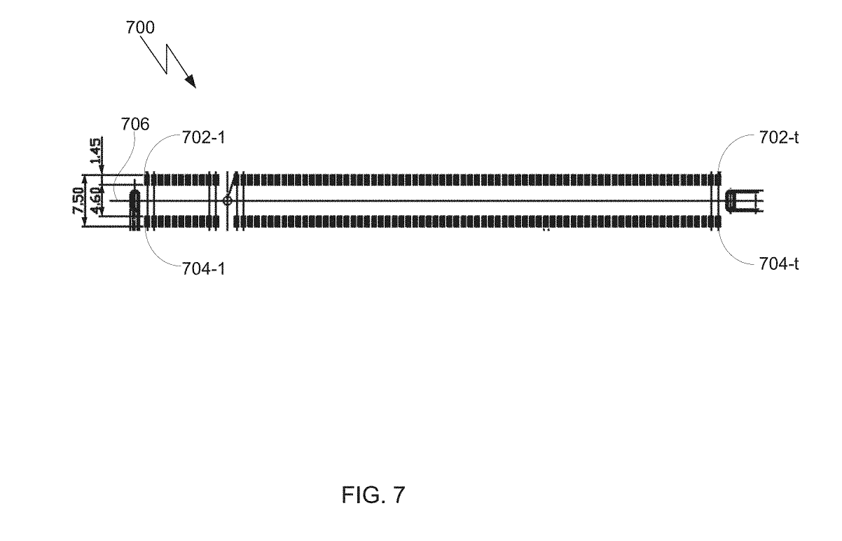

FIG. 7 illustrates an example solder pad layout 700, on a printed circuit board (e.g., PCB 204), for an expansion slot connector (e.g., slot connector 200) according to various embodiments of the present invention. Dimensions shown in FIG. 7 are in millimeters. The solder pad layout 700 includes solder pads 702-1 through 702-t and 704-1 and 704-t arranged in substantially opposing rows that are substantially symmetrical about an axis 706. The axis 706 is parallel and aligned with the lengthwise axis 302 of the connector body 202. As shown in FIG. 7, the distance between the inner ends (the solder pad end closest to axis 706) of solder pads 702 and 704 is approximately 4.60 millimeters. The distance between the outer ends (the solder pad end furthest from axis 706) of solder pads 702 and 704 is approximately 7.50 millimeters. The length of a solder pad 702 or 704 is approximately 1.45 millimeters. The length of a termination sub-portion 226 may be approximately the same as the length of the solder pad 702/704. That is, the length of the solder pad 702/704 may correspond to dimension 306. Thus, the length of a termination sub-portion 226 may be approximately 1.45 millimeters. In some embodiments, the lengths of the solder pads 702/706 define an upper bound on the lengths of the termination sub-portions 226. In some embodiments, solder pads 702/704, and thus also the termination sub-portions 226, may have lengths that is within a range of 1.30-1.60 millimeters, which is plus/minus 0.15 millimeters about the 1.45-millimeter length shown in FIG. 7.

As can be seen from FIGS. 2-3 and 7, the physical footprint of the slot connector 200 is reduced compared to that of a conventional slot connector (e.g., slot connector 100) when the lengths of the termination sub-portions 226 are reduced. The slot connector 200, when mounted, occupies less space on the PCB than a conventional slot connector. In this manner, the slot connector 200 offers an advantage of saving space on the PCB, allowing components to be located closer together on the PCB without conflicting. In some embodiments, a slot connector 200 associated with solder pad lengths as shown in FIG. 7, and thus having termination sub-portion 226 lengths corresponding to the solder pad lengths as shown in FIG. 7, have improved signal integrity compared to a conventional slot connector 100 associated with solder pad lengths as shown in FIG. 6.

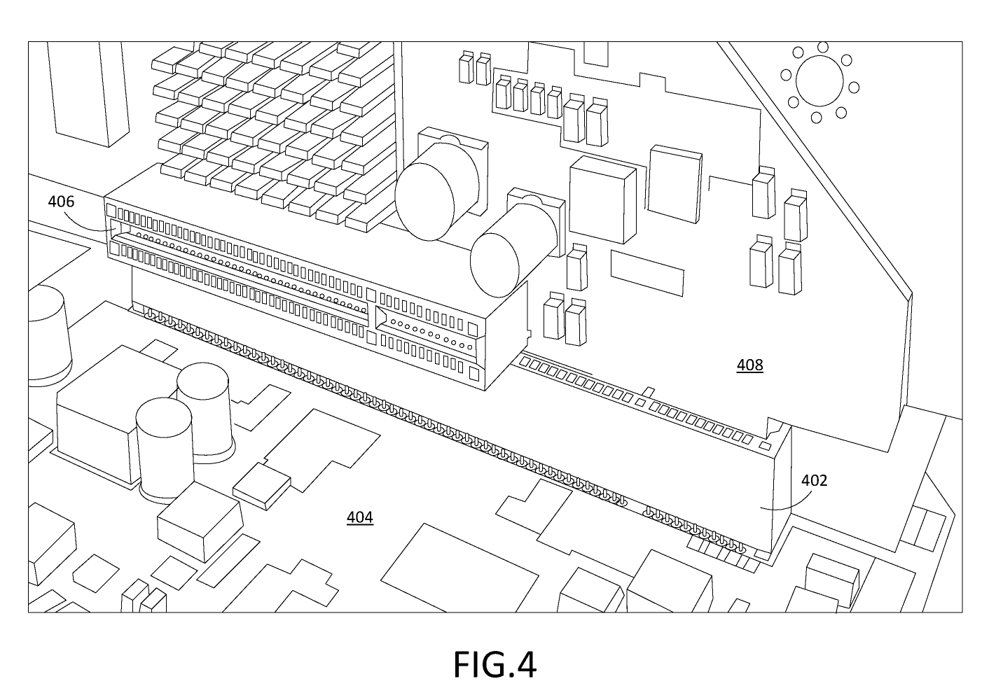

FIG. 4 is an image illustrating example expansion slot connectors, according to various embodiments of the present invention. FIG. 4 shows a slot connector 402, which may be configured in accordance with various embodiments of the present invention, mounted onto a printed circuit board 404. Also shown in FIG. 4 is a riser card 408 inserted into slot connector 402. Mounted onto the riser card 408 is a slot connector 406 configured in accordance with various embodiments of the present invention. As shown in FIG. 4, the termination sub-portions of slot connector 406 do not come into contact with slot connector 402 while the riser card 408 is inserted in slot connector 402. Thus, slot connector 406 does not physically conflict with slot connector 402. In this manner, slot connectors configured in accordance with various embodiments of the present invention offer an advantage of allowing a slot connector on a riser card to be located closer to the edge connector of the riser card while avoiding conflicts between the slot connector on the riser card and a slot connector into which the riser card is inserted.

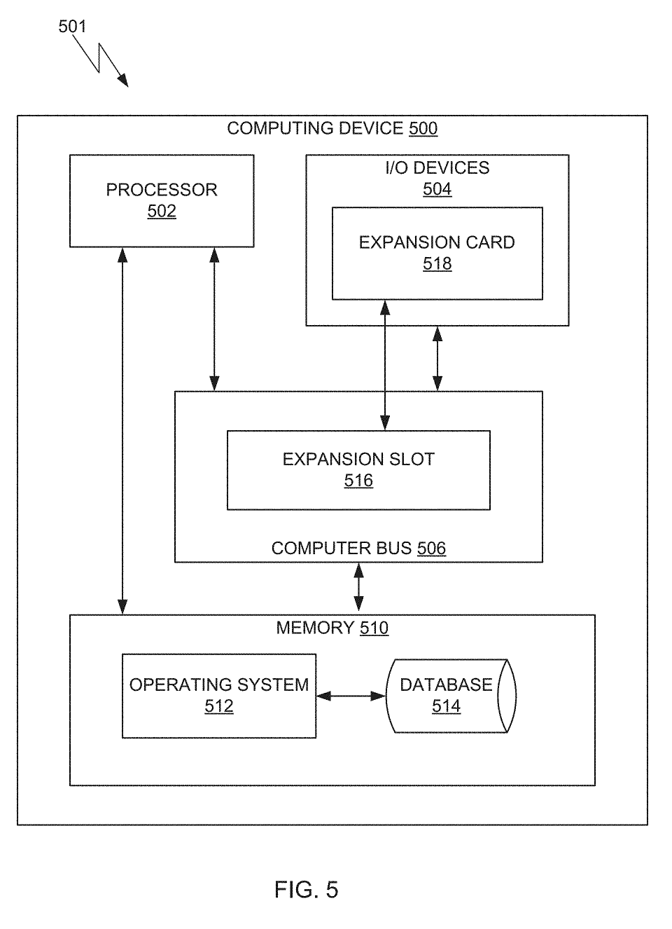

FIG. 5 illustrates a computer system, in accordance with various embodiments of the present invention. A computing system 501 includes a computing device 500. The computing device 500 includes one or more processors 502, one or more I/O devices 504, memory 510, and a computer bus 506 interconnecting these components. The computer bus 506 conforms to a defined standard (e.g., PCI Express 4.0). In some embodiments, the one or more processors 502 may access memory 510 directly, as well as through the computer bus 506. Memory 510 includes an operating system 512 and data structures for storing data (e.g., a database 514).

The computer bus 506 includes an expansion slot 516 that accepts I/O devices 504 in the form of expansion cards 518. The expansion slot 516 includes a slot connector configured in accordance with various embodiments of the present invention (e.g., slot connector 200, FIG. 2). An expansion card 518 is inserted into the slot connector of the expansion slot 516 to couple the expansion card 518 to the computer bus 506.

In sum, termination sub-portions of a slot connector are configured with a reduced length compared to the termination sub-portions of conventional slot connectors. The length reduction may be any amount, as long as the slot connector is configured to comply with a defined standard and accepted signal integrity levels, and optionally with manufacturer specifications and industry conventions. The reduced-length termination sub-portions may extend beyond the outer walls of the slot connector body, be flush with the slot connector body, or not extend beyond the slot connector body. The slot connector may include support pillars configured to be inserted into pre-drilled holes in a printed circuit board.

An advantage of this configuration is that the physical footprint of the slot connector is reduced, saving space on the printed circuit board. The reduced physical footprint allows the slot connector to be located closer to other components on the printed circuit board while still avoiding conflict with the other components.

Another advantage of this configuration is that the slot connector, when mounted on a riser card, may be located closer to the edge connector of the riser card without conflict with the edge connector or with a slot connector into which the riser card is inserted.

A further advantage of this configuration is that slot connectors mounted by the through-hole method to a printed circuit board may be replaced or upgraded with slot connectors configured in accordance with various embodiments of the present invention without changing the printed circuit board layout design and without conflict with other components on the printed circuit board.

1. In some embodiments, an apparatus comprises an expansion slot connector configured to be mountable onto a printed circuit board (PCB), the expansion slot connector comprising: a connector body; and a plurality of conductive elements arranged within the connector body, each conductive element including a mounting portion protruding from the connector body, the mounting portion including a termination sub-portion, the termination sub-portion having a length of 1.30-1.60 millimeters; wherein, when the expansion slot connector is mounted onto the PCB, the termination sub-portion is coupled to the PCB and is substantially parallel to the PCB.

2. The apparatus of clause 1, wherein the expansion slot connector further includes one or more support pillars configured to be inserted into respective holes pre-drilled through the PCB.

3. The apparatus of clauses 1 or 2, wherein the expansion slot connector conforms to the PCI Express 4.0 standard.

4. The apparatus of any of clauses 1-3, wherein a plurality of characteristics associated with the conductive element is configured to substantially maintain a predefined impedance range throughout the conductive element, the plurality of characteristics comprising: a length of the conductive element, and a length of the termination sub-portion.

5. The apparatus of any of clauses 1-4, wherein the predefined impedance range is 100 ohms+/−20%.

6. The apparatus of any of clauses 1-5, wherein the predefined impedance range is 85 ohms+/−10%.

7. The apparatus of any of clauses 1-6, wherein the plurality of characteristics further include a thickness of the conductive element.

8. In some embodiments, an apparatus comprises an expansion slot connector configured to be mountable onto a printed circuit board (PCB), the expansion slot connector comprising: a connector body; and a plurality of conductive elements arranged within the connector body, each conductive element including a mounting portion protruding from the connector body, the mounting portion including a termination sub-portion, wherein, when the slot connector is mounted onto the PCB, the termination sub-portion is coupled to the PCB and is substantially parallel to the PCB, and wherein a plurality of characteristics associated with the conductive element is configured to substantially maintain a predefined impedance range throughout the conductive element, the plurality of characteristics including: a length of the conductive element, and a length of the termination sub-portion.

9. The apparatus of clause 8, wherein the length of the termination sub-portion is configured such that the end of the termination sub-portion is substantially flush with an outer wall of the connector body.

10. The apparatus of clauses 8 or 9, wherein the length of the termination sub-portion is configured such that the termination sub-portion extends no further than an outer wall of the connector body.

11. The apparatus of any of clauses 8-10, wherein the predefined impedance range is 100 ohms+/−20%.

12. The apparatus of any of clauses 8-11, wherein the predefined impedance range is 85 ohms+/−10%.

13. The apparatus of any of clauses 8-12, wherein the plurality of characteristics further include a thickness of the conductive element.

14. In some embodiments, a system comprises a printed circuit board (PCB); and an expansion slot connector mounted onto the PCB, the expansion slot connector comprising: a connector body; and a plurality of conductive elements arranged within the connector body, each conductive element including a mounting portion protruding from the connector body, the mounting portion including a termination sub-portion, the termination sub-portion having a length of 1.30-1.60 millimeters; wherein, when the expansion slot connector is mounted onto the PCB, the termination sub-portion is coupled to the PCB and is substantially parallel to the PCB.

15. The system of clause 14, wherein the expansion slot connector further includes one or more support pillars configured to be inserted into respective holes pre-drilled through the PCB.

16. The system of clauses 14 or 15, wherein the expansion slot connector conforms to the PCI Express 4.0 standard.

17. The system of any of clauses 14-16, wherein a plurality of characteristics associated with the conductive element is configured to substantially maintain a predefined impedance range throughout the conductive element, the plurality of characteristics comprising: a length of the conductive element, and a length of the termination sub-portion.

18. The system of any of clauses 14-17, wherein the predefined impedance range is 100 ohms+/−20%.

19. The system of any of clauses 14-18, wherein the predefined impedance range is 85 ohms+/−10%.

20. The system of any of clauses 14-19, wherein the connector body comprises an outer wall and a chamfered edge along a lower portion of the outer wall.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. An apparatus, comprising:
an expansion slot connector configured to be mountable onto a printed circuit board (PCB), the expansion slot connector comprising:
a connector body; and
a plurality of conductive elements arranged within the connector body, each conductive element including a mounting portion protruding from the connector body, the mounting portion including a termination sub-portion, the termination sub-portion having a length of 1.30-1.60 millimeters;
wherein, when the expansion slot connector is mounted onto the PCB, the termination sub-portion is coupled to the PCB and is substantially parallel to the PCB.

2. The apparatus of claim 1, wherein the expansion slot connector further includes one or more support pillars configured to be inserted into respective holes pre-drilled through the PCB.

3. The apparatus of claim 1, wherein the expansion slot connector conforms to the PCI Express 4.0 standard.

4. The apparatus of claim 1, wherein a plurality of characteristics associated with the conductive elements are configured to substantially maintain a predefined impedance range throughout the conductive elements, the plurality of characteristics comprising: a length of the conductive elements, and a length of the termination sub-portion.

5. The apparatus of claim 4, wherein the predefined impedance range is 100 ohms+/−20%.

6. The apparatus of claim 4, wherein the predefined impedance range is 85 ohms+/−10%.

7. The apparatus of claim 4, wherein the plurality of characteristics further include a thickness of the conductive element.

8. An apparatus, comprising:
an expansion slot connector configured to be mountable onto a printed circuit board (PCB), the expansion slot connector comprising:
a connector body; and
a plurality of conductive elements arranged within the connector body, each conductive element including a mounting portion protruding from the connector body, the mounting portion including a termination sub-portion, the termination sub-portion having a length of 1.30-1.60 millimeters,
wherein, when the slot connector is mounted onto the PCB, the termination sub-portion is coupled to the PCB and is substantially parallel to the PCB, and
wherein a plurality of characteristics associated with the conductive element is configured to substantially maintain a predefined impedance range throughout the conductive element, the plurality of characteristics including:
a length of the conductive element, and
a length of the termination sub-portion.

9. The apparatus of claim 8, wherein the length of the termination sub-portion is configured such that the end of the termination sub-portion is substantially flush with an outer wall of the connector body.

10. The apparatus of claim 8, wherein the length of the termination sub-portion is configured such that the termination sub-portion extends no further than an outer wall of the connector body.

11. The apparatus of claim 8, wherein the predefined impedance range is 100 ohms+/−20%.

12. The apparatus of claim 8, wherein the predefined impedance range is 85 ohms+/−10%.

13. The apparatus of claim 8, wherein the plurality of characteristics further include a thickness of the conductive element.

14. A system, comprising:
a printed circuit board (PCB); and
an expansion slot connector mounted onto the PCB, the expansion slot connector comprising:
a connector body; and
a plurality of conductive elements arranged within the connector body, each conductive element including a mounting portion protruding from the connector body, the mounting portion including a termination sub-portion, the termination sub-portion having a length of 1.30-1.60 millimeters;
wherein, when the expansion slot connector is mounted onto the PCB, the termination sub-portion is coupled to the PCB and is substantially parallel to the PCB.

15. The system of claim 14, wherein the expansion slot connector further includes one or more support pillars configured to be inserted into respective holes pre-drilled through the PCB.

16. The system of claim 14, wherein the expansion slot connector conforms to the PCI Express 4.0 standard.

17. The system of claim 14, wherein a plurality of characteristics associated with the conductive element is configured to substantially maintain a predefined impedance range throughout the conductive element, the plurality of characteristics comprising: a length of the conductive element, and a length of the termination sub-portion.

18. The system of claim 17, wherein the predefined impedance range is 100 ohms+/−20%.

19. The system of claim 17, wherein the predefined impedance range is 85 ohms+/−10%.

20. The system of claim 17, wherein the connector body comprises an outer wall and a chamfered edge along a lower portion of the outer wall.
